(19) United States
(12) Patent Application Publication
(10) Pub. No.: US 2009/0314886 A1
(43) Pub. Date: Dec. 24, 2009

(54) DEPLOYMENT OF TELESCOPING AIRCRAFT STRUCTURES BY DROGUE PARACHUTE RISER TENSION

(75) Inventors: Tom Clancy, Washington, DC (US); Robert Parks, San Jose, CA (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: Aurora Flight Sciences Corporation, Manassas, VA (US)

(21) Appl. No.: 12/137,901

(22) Filed: Jun. 12, 2008

Related U.S. Application Data
(60) Provisional application No. 60/943,830, filed on Jun. 13, 2007.

(51) Int. Cl. B64C 1/00; B64C 3/56; B64C 25/10

(52) U.S. Cl. 244/1 TD; 244/49; 244/102 R; 24/115 R

(57) ABSTRACT

A system for deploying a deployable structure in an aircraft, comprising a drogue parachute, at least one deployable structure, a riser line attached to the drogue parachute and the at least one deployable structure, wherein when the drogue parachute is deployed, a tension is applied to the riser line, and a parachute deployment system, wherein the parachute deployment system is configured to utilize the applied tension to deploy the at least one deployable structure.

### PRIORITY

The present application claims priority under 35 U.S.C. § 119(e) to U.S. Provisional Patent Application No. 60/943,830, filed Jun. 13, 2007, the entire contents of which are herein expressly incorporated by reference.

### BACKGROUND OF THE INVENTION

1. Field of the Invention

The invention is related to light-weight aircraft. More particularly, the invention is related to a system and method for extending telescoping aircraft structures without use of existing or auxiliary engines.

2. Background Art

For many types of foldable aircraft, telescoping structures have several advantages. They are simple, light, and inherently occupy a very small amount of stowed volume. However, deployment of such structures typically requires very large displacements of an actuating device. In conventional systems, either inflatable bladders with a compressed gas supply, or a cable and winch system would be used. In addition, the power to operate such devices might have to be provided by a main engine or an auxiliary engine, thereby increasing weight, and/or using precious fuel supplies.

Thus, a need exists for a telescoping aircraft structure deployment system that can produce a large amount of work (i.e. force times displacement) for low mass.

### SUMMARY OF THE INVENTION

It is therefore a general aspect of the invention to provide a telescoping structure deployment system that will obviate or minimize problems of the type previously described.

It is now becoming common to launch an unmanned aircraft in a folded configuration. The folding allows a large aircraft to be stowed and carried or launched in some sort of a small volume container. In many cases, the aircraft is launched by a small booster rocket, such as a typical cruise missile. In this case the aircraft is unfolded immediately after exiting the container, while still at low airspeed, and thus with low air loads. However, in other cases, the aircraft can be launched from a larger aircraft flying at high speed, or it can be launched to a high altitude by a large booster rocket, or it can even be launched to another planet. In all of these cases the aircraft must deploy itself at a high airspeed, with high aerodynamic forces. It is often desirable to use some sort of a parachute system to stabilize the aircraft as it unfolds, and sometimes the parachute is also used to retard or even decelerate the aircraft to further minimize the aerodynamic loads on the aircraft. Accordingly, several exemplary embodiments make use of the drag force on the parachute to provide a large amount of work to effectively deploy the aircraft with little or no additional weight penalty. While the exemplary embodiment has particular applicability to telescoping structures, which inherently require very large displacements for deployment, the structural deployment system is also useful for deploying hinged type structures. If the parachute is large enough to decelerate the aircraft, the force available is greater than the weight of the aircraft.

According to a first aspect of the present invention, a system for deploying a deployable structure in an aircraft is provided comprising a drogue parachute; at least one deployable structure; a riser line attached to the drogue parachute and the at least one deployable structure, wherein when the drogue parachute is deployed, a tension is applied to the riser line; and a parachute deployment system, wherein the parachute deployment system is configured to utilize the applied tension to deploy the at least one deployable structure.

According to the first aspect, the parachute deployment system comprises: one or more pulley wheels; and at least one cable connected to the deployable structure, interfaced with the one or more pulley wheels, and mechanically coupled to the riser line. The first aspect further comprises a cable cutter configured to sever the cable following extension of the at least one deployable structure. According to a first aspect, the parachute deployment system further comprises one or more jam cleats, wherein each of the one or more jam cleats is configured to allow substantially one-way travel of the at least one cable in the direction of the applied tension following deployment of the drogue parachute.

According to the first aspect, the parachute deployment system further comprises one or more deployment rate limiters, wherein the at least one cable interfaces with at least one of the one or more deployment rate limiters, and wherein each of the one or more deployment rate limiters is configured to limit a deployment rate of a corresponding one of the at least one deployable structures.

According to the first aspect, each deployment rate limiter is configured to provide a braking force to the cable, when a rate at which the corresponding deployable structure exceeds a first predetermined deployed rate, and the deployment rate limiter is further configured to reduce a rate of deployment of the deployable structure as a deployment of the corresponding deployable structure approaches a substantially completed condition. According to the first aspect, the deployment rate limiter is further configured to substantially prevent or reduce damage to the deployable structure.

According to the first aspect, the parachute deployment system comprises: a plurality of tubes; and at least one cable connected to the deployable structure, interfaced with each of the plurality of tubes, and mechanically coupled to the drogue parachute, wherein each of the plurality of tubes is configured to redirect the applied tension to one or more components of the at least one deployable structure.

The first aspect further comprises a cable cutter configured to sever the cable following extension of the at least one deployable structure, and one or more jam cleats, wherein each of the one or more jam cleats is configured to allow substantially one-way travel of the at least one cable in the direction of the applied tension following deployment of the drogue parachute.

The first aspect further comprises one or more deployment rate limiters, wherein the at least one cable interfaces with at least one of the one or more deployment rate limiters, and wherein each of the one or more deployment rate limiters is configured to limit a deployment rate of a corresponding one of the at least one deployable structures.

According to the first aspect, each deployment rate limiter is configured to provide a braking force to the cable, when a rate at which the corresponding deployable structure exceeds a first predetermined deployed rate, and wherein the deployment rate limiter is further configured to reduce a rate of deployment of the deployable structure as a deployment of the corresponding deployable structure approaches a substantially completed condition. Further still according to the first aspect, the deployment rate limiter is further configured to substantially prevent or reduce damage to the deployable structure.

According to the first aspect, the at least one the deployable structure comprises a telescoping wing structure, the at least one deployable structure comprises a foldable wing structure, or the at least one deployable structure comprises a landing gear structure.

According to a second aspect of the present invention, a system for deploying a structure in an aircraft is provided comprising: a drogue parachute; at least one deployed structure; a riser line attached to the drogue parachute and the at least one deployable structure, wherein when the drogue parachute is deployed, a tension is applied to the riser line; and a pulley system, wherein the pulley system is configured to utilize the applied tension to deploy the at least one deployable structure.

According the second aspect, the at least one deployable structure comprises a telescoping structure, or the at least one deployable structure comprises a foldable structure.

According to a third aspect of the present invention, an aircraft is provided comprising: a fuselage; a deployable wing structure appended to the fuselage; a plurality of deployable vertical and horizontal stabilizer structures appended to the fuselage; and a system for deploying a deployable structure in the aircraft, the system including a drogue parachute; a riser line attached to the drogue parachute and each of the deployable wing structure and plurality of deployable vertical and horizontal stabilizer structures, wherein when the drogue parachute is deployed, a tension is applied to the riser line; and a parachute deployment system, wherein the parachute deployment system is configured to utilize the parachute riser line tension to deploy each of the deployable wing structure and plurality of deployable vertical and horizontal stabilizer structures.

According to the third aspect, the parachute deployment system comprises: at least one pulley wheel; and at least one cable connected to the deployable structure, interfaced with the at least one more pulley wheel, and mechanically coupled to the drogue parachute.

According to the third aspect, the aircraft further comprises a cable cutter configured to sever the cable following extension of each of the deployable wing structure and plurality of deployable vertical and horizontal stabilizer structures.

According to the third aspect, the aircraft further comprises one or more jam cleats, wherein each of the one or more jam cleats is configured to allow substantially one-way travel of the at least one cable in the direction of the applied tension following deployment of the drogue parachute.

According to the third aspect, the aircraft further comprises one or more deployment rate limiters, wherein the at least one cable interfaces with at least one of the one or more deployment rate limiters, and wherein each of the one or more deployment rate limiters is configured to limit a deployment rate of a corresponding one of each of the deployable wing structure and plurality of deployable vertical and horizontal stabilizer structures.

According to the third aspect, each deployment rate limiter is configured to provide a braking force to the cable, when a rate at which each of the deployable wing structure and plurality of deployable vertical and horizontal stabilizer structures exceeds a first predetermined deployed rate.

According to the third aspect, the deployment rate limiter is further configured to reduce a rate of deployment of each of the deployable wing structure and plurality of deployable vertical and horizontal stabilizer structures as deployment of the corresponding deployable wing structure and plurality of deployable vertical and horizontal stabilizer structures approaches a substantially completed condition.

According to the third aspect, the deployment rate limiter is further configured to prevent or reduce damage to each of the deployable wing structure and plurality of deployable vertical and horizontal stabilizer structures.

According to the third aspect, the parachute deployment system comprises: a plurality of tubes; and at least one cable connected to each of the deployable wing structure and plurality of deployable vertical and horizontal stabilizer structures, interfaced with each of the plurality of tubes, and mechanically coupled to the drogue parachute, wherein each of the plurality of tubes is configured to redirect the applied tension to each of the deployable wing structure and plurality of deployable vertical and horizontal stabilizer structures.

According to the third aspect, the aircraft further comprises a cable cutter configured to sever the cable following extension of each of the deployable wing structure and plurality of deployable vertical and horizontal stabilizer structures, one or more jam cleats, wherein each of the one or more jam cleats is configured to allow substantially one-way travel of the at least one cable in the direction of the applied tension following deployment of the drogue parachute.

According to the third aspect, the aircraft further comprises one or more deployment rate limiters, wherein the at least one cable interfaces with at least one of the one or more deployment rate limiters, and wherein each of the one or more deployment rate limiters is configured to limit a deployment rate of a corresponding one of each of the deployable wing structure and plurality of deployable vertical and horizontal stabilizer structures.

According to the third aspect, each deployment rate limiter is configured to provide a braking force when a rate at which the corresponding deployable wing structure and plurality of deployable vertical and horizontal stabilizer structures exceeds a first predetermined deployment rate.

According to the third aspect, the deployment rate limiter is further configured to reduce a rate of deployment of each of the deployable wing structure and plurality of deployable vertical and horizontal stabilizer structures, and the deployment rate limiter is further configured to prevent or reduce damage to the deployable structure.

According to the third aspect, the aircraft comprises a lightweight aircraft, the aircraft comprises a solar powered aircraft, and the aircraft comprises a sail plane.

According to a fourth aspect of the present invention, a method for deploying a deployable structure on an airborne aircraft is provided comprising the steps of: deploying a drogue parachute from the airborne aircraft, wherein the drogue parachute is mechanically coupled to the deployable structure; and using a tension force being applied as a result of the deployed drogue parachute to enable deployment of the deployable structure.

According to the fourth aspect, the step of using the tension force comprises: redirecting the applied tension force through at least one pulley wheel and at least one cable connected to the deployable structure, the at least one cable being interfaced with the at least one pulley wheel, and mechanically coupled to the drogue parachute.

According to the fourth aspect, the step using the tension force comprises: redirecting the applied tension force through at least one tube and at least one cable connected to the deployable structure, the at least one cable being interfaced with the at least one pulley wheel, and mechanically coupled to the drogue parachute.

According to the fourth aspect, the method further comprises: using at least one deployment rate limiter to limit a rate of deployment of the deployable structure, and the step of using at least one deployment rate limiter comprises: providing a braking force should deployment of the deployable structure exceed a first predetermined deployment rate.

According to the fourth aspect, the step of providing a braking force comprises: reducing the rate of deployment of the deployable structure as the corresponding deployable structure approaches a substantially completed condition.

According to the fourth aspect, the method further comprises reducing the rate of deployment of the deployable structure to substantially prevent or reduce damage to the deployable structure.

According to the fourth aspect, the deployable structure comprises a telescoping wing structure, the deployable structure comprises a foldable wing structure, and the deployable structure comprises a landing gear structure.

### BRIEF DESCRIPTION OF THE DRAWINGS

The novel features and advantages of the present invention will best be understood by reference to the detailed description of the preferred embodiments that follows, when read in conjunction with the accompanying drawings, in which:

FIG. 1 illustrates a schematic drawing of drogue parachute telescoping aircraft structure deployment pulley and cable system (parachute deployment system) according to an embodiment of the present invention.

FIG. 2 illustrates close-up view of the parachute deployment system shown in FIG. 1.

FIG. 3 illustrates the parachute deployment system shown in FIG. 1 following completion of deployment of the telescoping aircraft structure.

FIGS. 4A-4C illustrate deployment of a foldable wing according to an embodiment of the present invention.

FIGS. 5A and 5B illustrate deployment of a landing gear structure according to an embodiment of the present invention.

### DETAILED DESCRIPTION OF THE PREFERRED EMBODIMENTS

The various features of the preferred embodiments will now be described with reference to the drawing figures, in which like parts are identified with the same reference characters. The following description of the presently contemplated best mode of practicing the invention is not to be taken in a limiting sense, but is provided merely for the purpose of describing the general principles of the invention.

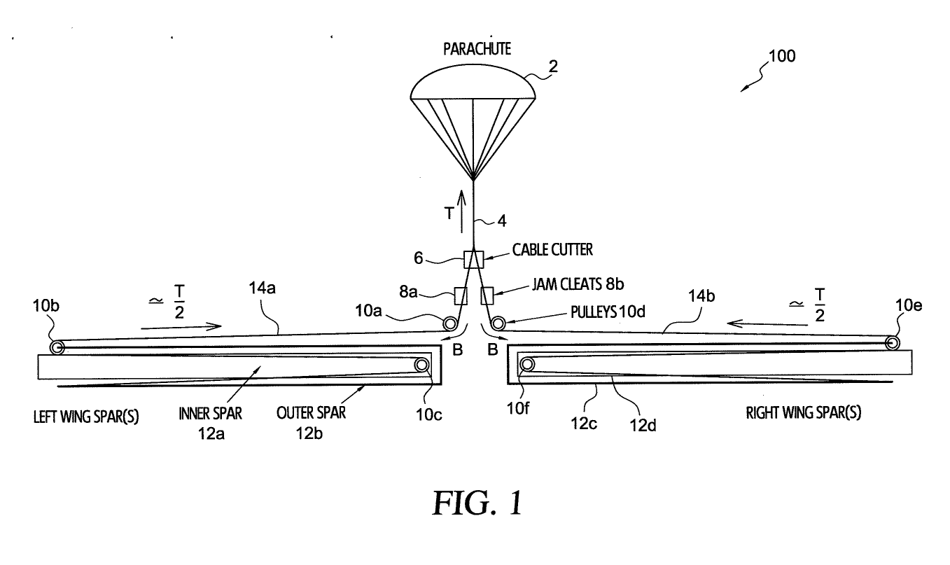

According to an exemplary embodiment, a drogue parachute telescoping aircraft structure deployment pulley and cable system (parachute deployment system) 100 uses a series of cables and pulleys to deploy telescoping/foldable aircraft structures (hereinafter referred to as “deployable structures”) for light-weight aircraft 50. According to an exemplary embodiment, light-weight aircraft 50 is defined to weigh less than about 5,000 lbs or less. According to a preferred embodiment, the telescoping structure is a wing spar structure. According to further exemplary embodiments, other aircraft structures that can be deployed include foldable wings, fold-out landing gear, vertical and horizontal flight control surfaces, portions of an aircraft fuselage, propellers, among other aircraft structures. There can be at least one or more wing spar segments that can be telescoped within each other. According to an exemplary embodiment, a significantly large mechanical advantage can be obtained using standard block and tackle configurations, depending upon the forces required. As shown in FIG. 1, discussed in detail infra, the cables from each wing can be routed to the center of the aircraft, and around one or more pulleys such that they exit the aft end of light-weight aircraft 50.

As those of ordinary skill in the art can appreciate, light-weight aircraft 50 that are released or propelled to an altitude for use require some sort of a drogue parachute (chute) 2 to limit the airspeed and air loads during deployment of the deployable aircraft structures. Once in equilibrium descent, the drag on parachute 2 can be roughly equal to the weight of light-weight aircraft 50, and this results in a tension on parachute riser line (riser line) 4. The tension in riser line 4 can be referred to as parachute (chute) riser line tension T, as shown in FIG. 1. By attaching riser line 4 to cables 14 from telescoping wing spars 12a-d, nearly all of the parachute riser line tension T can be applied through parachute deployment system 100 to the deployable structures (in this exemplary embodiment, wing spars 12a-d). According to an exemplary embodiment, cable 14 can be considered to be mechanically coupled to parachute 2 whether it is directly connected to parachute 2, or connected to riser line 4 that is connected to parachute 2. The total travel of cable 14 as used within parachute deployment system 100 can be quite large, and is limited only by the differential velocity limits between parachute 2 and light-weight aircraft 50 and the time available for deployment. According to an exemplary embodiment, the left and right wings can be coupled to the same riser line 4, as shown in FIG. 1, discussed infra. If riser line 4 is split between left wing spars 12a, b, and right wing spars 12c, d, then parachute riser line tension T is about equally split between cables 14a, b, and equals about T/2 as shown in FIG. 1. If either side binds up, then the parachute deployment system 100 inherently applies the full riser or braking force to the side that is binding. In this case, the parachute riser line tension T present in riser line 4 is nearly completely transferred to the bound cable 14, and the tension in cable 14 goes from about T/2 to about T.

According to a further exemplary embodiment, the deployment rate can be limited in order to prevent or minimize opening shock. According to a preferred embodiment, riser line 4 can be routed through a sail type winch (winch) 16 (not shown), wherein the winch 16 can utilize a braking or escapement mechanism to limit and control the deployment rate of the telescoping aircraft structure. Other types of rate limiting devices can also be used, including, for example, a motor-pulley arrangement, flexible and non-flexible hoses or tubes, clamping devices (using motors and speed sensors), among other devices. Collectively, the devices for limiting the deployment rate can be referred to as a braking force application system. Furthermore, “reefing” devices, well known to those of ordinary skill in the parachute arts, slow deployment of parachute 2. Even though deployment of parachute 2 can be slowed down in any one of several different methods, enough riser line tension T can be available to “jerk” the deployable structure from its stored state, and get it moving.

According to an exemplary embodiment, winches 16 and pulleys 10 are another example of a braking force application system. Other non-limiting examples of a braking force application system include a plurality of flexible tubes within which are located cables 14. Flexible tubes can also be used to slow deployment of deployable structures by imparting friction to cables 14.

Braking force B, as shown in FIG. 1, is a force directed against the direction of travel of cable 14 (which occurs in the same direction that parachute riser line tension T is applied, also as shown in FIG. 1). According to an exemplary embodiment, as shown in FIG. 1, the braking force B is provided by pulleys 10a, b, which can be pre-set, or computer controlled, to provide constant and/or variable (i.e., time varying) amounts of braking force B to slow down deployment of the deployable structures. According to a preferred embodiment, braking force application system is computer controlled and monitors the rate of deployment of the deployable structures. The braking force application system according to this preferred embodiment can allow deployment rates up to a first predetermined rate, and then, when deployment of the deployable structures is nearly complete, apply braking force to slow deployment to a second predetermined rate so that shock and consequent damage can be avoided and/or minimized. According to further exemplary embodiments, the amount of braking force B can vary over time, so that the rate of deployment can vary (i.e., constant speed, constant deceleration, or even variable deceleration). Further still, the braking force application system can substantially slow down deployment of the deployable structure as it is being substantially completely deployed to prevent or reduce damage to the deployable structure.

Accordingly, FIG. 1 illustrates a schematic drawing of parachute deployment system 100 according to an exemplary embodiment (i.e., for left and right wing spans 12a-d). As shown in FIG. 1, only one telescoping segment is shown for both left and right wing spars 12a-d, but with additional pulleys 10 and loops of cable 14, additional spar segments 12 can be added. Further, according to additional exemplary embodiments, multiple block and tackle arrangements can be used, as is similarly used to lift heavy loads with cranes for loading into ships or other storage containers; block and tackle arrangements increase the extension force of deployed parachute 2. As those of ordinary skill in the art can appreciate, however, use of one or more block and tackle arrangements decreases the amount of force required to move or lift and object (in this case, the deployable structures), but at the expense of additional cable 14 travel.

According to an exemplary embodiment, stiff tubes or pulleys 10 can be made to be relatively frictionless and can therefore redirect parachute riser line tension T to required locations within light-weight aircraft 50 without imposing any braking force. According to a further exemplary embodiment, cables 14 can be replaced with chain, metal cables, rope (both natural and manmade rope), and linkages with pivots and other mechanical components for redirecting the parachute riser line tension T. All of the described examples for redirecting the riser tension force and the braking force application system are merely illustrative and are within the exemplary embodiments, and should not be construed to be limiting as to others that exist and can be used as well.

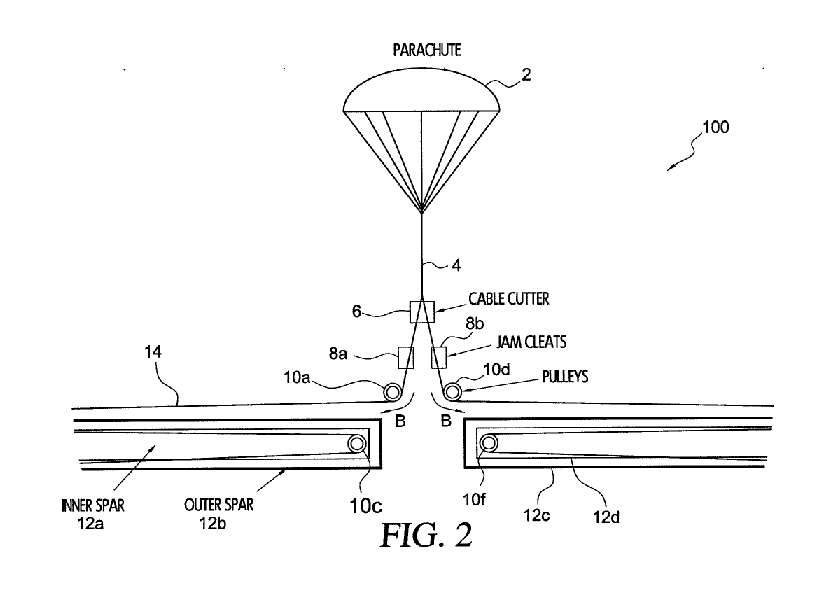

According to an exemplary embodiment, parachute 2 deploys, tensioning parachute riser line (riser line) 4, which runs through cable cutter 6, jam cleats 8 and pulleys 10a-c, becoming cable 14a. Pulleys 10a-c, redirect cable 14a as desired. According to an exemplary embodiment, cable 14a runs to the center of light-weight aircraft 50 then aft. As those of ordinary skill in the art can appreciate, the particular embodiment described herein should not be taken in a limiting manner, as it is only one such example of how parachute deployment system 100 can be configured. Each of cables 14a, b goes through its respective jam cleat 8a, b, to hold the deployable structure open once it is deployed. Both cables 14a, b run through cable cutter 6 that is activated to sever cable 14, thereby releasing drogue parachute 2 once deployment is complete. FIG. 2 illustrates a close-up view of telescoping deployment system 100 shown in FIG. 1.

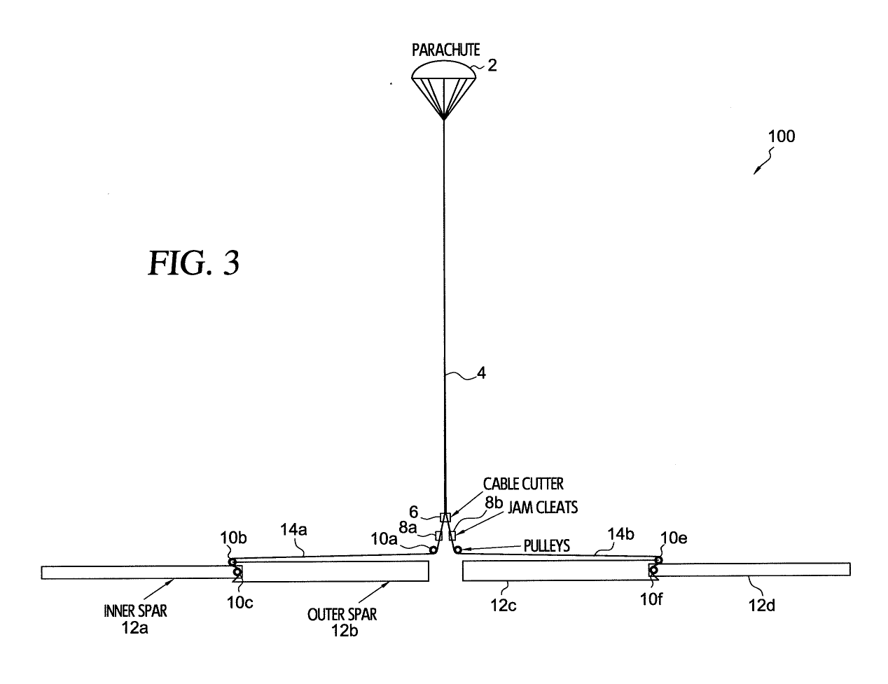

FIG. 3 illustrates parachute deployment system 100 following completion of deployment of telescoping spars 12a-d. According to an exemplary embodiment, FIG. 3 illustrates an overall view at the completion of the wing spar deployment but before the cables 14 are cut and released.

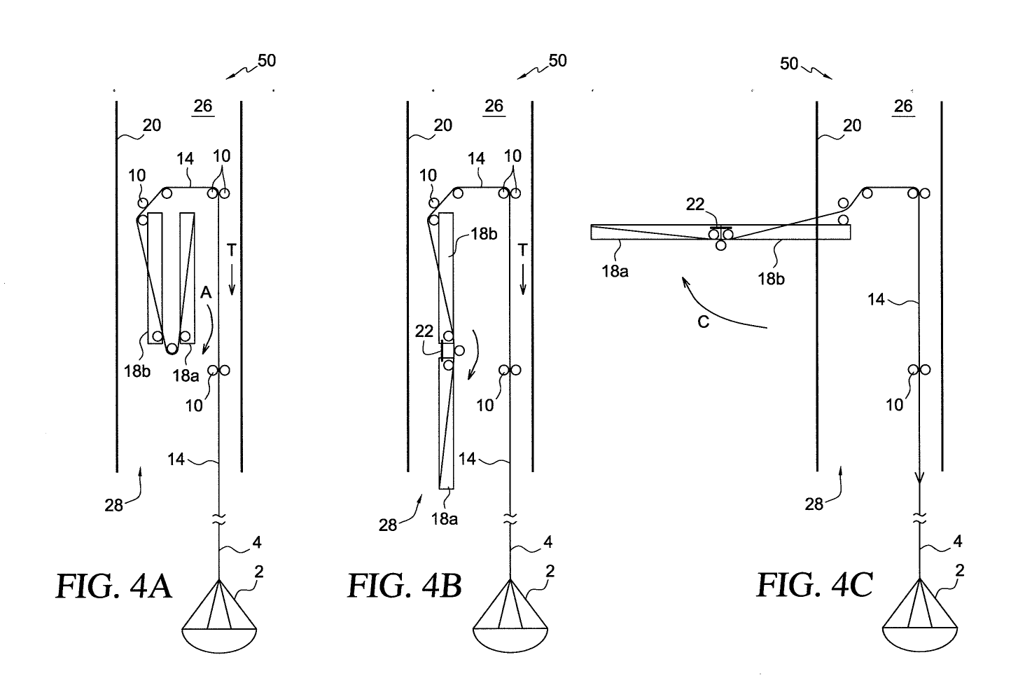

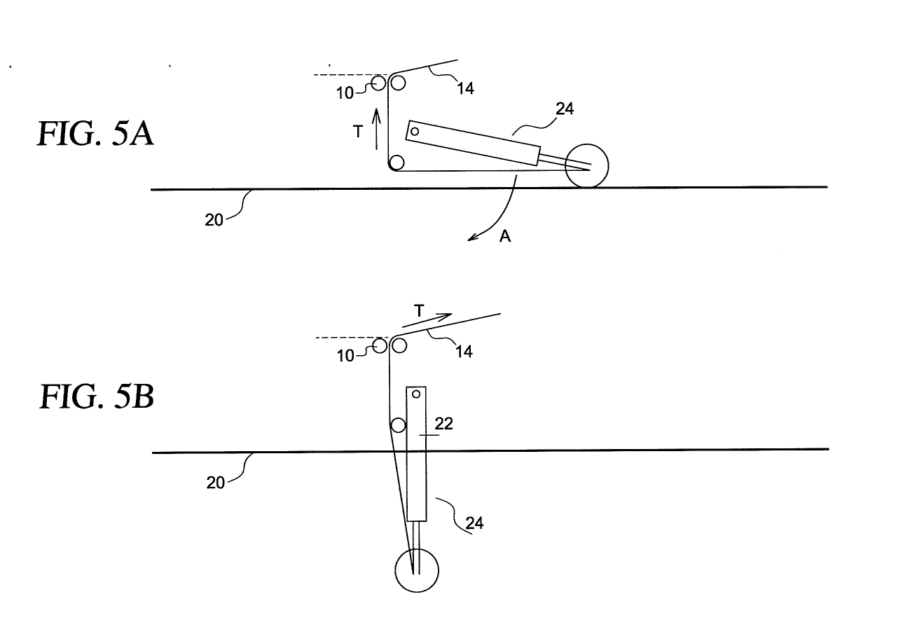

As discussed above, other deployable structures include foldable wings 18a, b, shown in FIGS. 4A-4C, and landing gear 24, shown in FIG. 5. According to a further exemplary embodiment, folding wings 18, b can also be combined with telescoping spars 12. Referring now to FIG. 4A, outer wing segment 18a and inner wing segment 18b are folded within fuselage 20. Light-weight aircraft 50 is falling nose first, with nose section 26 pointed downwards, and parachute 2 attached to tails section 28 of light-weight aircraft 50. In this manner, the wings of falling light-weight aircraft 50, folding wings 18a, b will generate lift as soon as they extended from fuselage 20. As those of ordinary skill in the art can appreciate, the diagram shown in FIGS. 4A-4C is but a rough approximation of how such a system would actually be configured and is not to be taken in a limiting fashion only, and it has been greatly simplified to illustrate the principles of the exemplary embodiments as discussed herein. Parachute 2 supplies parachute riser line tension T to cable 14 as shown in FIGS. 4A and 4B, causing wing segments 18a and 18b to deploy away from their stored state. Pulleys 10, one or more of which can be configured as part of braking force application system impart a predetermined amount of braking force on first outer wing segment 18a and then combined inner wing segment 18b and outer wing segment 18a, following deployment of parachute 2, as discussed in detail above, in order to prevent damage to wing segments 18a, b because of high speed deployment. According to an exemplary embodiment, the orientation of light-weight aircraft 50 as it falls following ejection and the orientation of folding wings 18 can be used to augment parachute riser line tension T provided by deployment of parachute 2. That is, because light-weight aircraft 50 is falling nose 26 first, and folding wings 18 extend downward then outward, their momentum and rotation (as shown in arrows A-C), and the effects of gravity, will assist in their deployment. Further, gravity and momentum can be used to augment parachute riser line tension T provided by deployed parachute 2 for other deployable structures (e.g., landing gear 24).

In FIG. 4B, outer wing segment 18a has been extended such that it lines up with inner wing segment 18b, and lock 22 locks the inner and outer wing segments together. Then, in FIG. 4C, cable 14 continues to pull now combined outer and inner wing segments 18a, b to their final fully extended position, and outer and inner wing segments 18a, b are now prepared to produce lift for light-weight aircraft 50.

FIGS. 5A and 5B illustrate extension of landing gear 24 according to another exemplary embodiment. In FIG. 5A, landing gear 24 is folded within landing gear well prior to deployment of light-weight aircraft 50. Cable 14 is attached to drogue parachute 2, though drogue parachute 2 is not shown in either FIGS. 5A and 5B. Once drogue parachute 2 is deployed, however, chute riser line tension T is present in cable 14 (as shown) and begins to deploy landing gear 24 along arc A. Cable 14 is guided by pulleys 10, one or more of which can be a deployment rate limiter, for the purpose of monitoring and limiting the rate of deployment of landing gear 24. As discussed above, the deployment rate limiters can slow down, and apply a braking force to retard the speed of deployment of a deployable device or structure, and can further substantially prevent or reduce damage that could otherwise be caused from deploying too quickly when the deployable device or structure is fully deployed. For example, if landing gear 24 were to be deployed at a maximum rate that chute riser line tension T can create in cable 14, landing gear 24 could b damaged when it fully deploys into its locked, landing configuration. Following full deployment of landing gear 24, as shown in FIG. 5B, lock 22 can lock landing gear in its fully deployed, landing configuration, for use when light-weight aircraft 50 lands. Other deployable structures include the fuselage or portions thereof, vertical and horizontal stabilizers.

The present invention has been described with reference to certain exemplary embodiments thereof. However, it will be readily apparent to those skilled in the art that it is possible to embody the invention in specific forms other than those of the exemplary embodiments described above. This may be done without departing from the spirit and scope of the invention. The exemplary embodiments are merely illustrative and should not be considered restrictive in any way. The scope of the invention is defined by the appended claims and their equivalents, rather than by the preceding description.

All United States patents and applications, foreign patents, and publications discussed above are hereby incorporated herein by reference in their entireties.

What is claimed is:

1. A system for deploying a deployable structure in an aircraft, comprising:
a drogue parachute;
at least one deployable structure;
a riser line attached to the drogue parachute and the at least one deployable structure, wherein when the drogue parachute is deployed, a tension is applied to the riser line; and
a parachute deployment system, wherein the parachute deployment system is configured to utilize the applied tension to deploy the at least one deployable structure.

2. The system according to claim 1, wherein the parachute deployment system comprises:
one or more pulley wheels; and
at least one cable connected to the deployable structure, interfaced with the one or more pulley wheels, and mechanically coupled to the riser line.

3. The system according to claim 2, further comprising:
a cable cutter configured to sever the cable following extension of the at least one deployable structure.

4. The system according to claim 2, further comprising:
one or more jam cleats, wherein
each of the one or more jam cleats is configured to allow substantially one-way travel of the at least one cable in the direction of the applied tension following deployment of the drogue parachute.

5. The system according to claim 2, further comprising:
one or more deployment rate limiters, wherein
the at least one cable interfaces with at least one of the one or more deployment rate limiters, and wherein
each of the one or more deployment rate limiters is configured to limit a deployment rate of a corresponding one of the at least one deployable structures.

6. The system according to claim 5, wherein each deployment rate limiter is configured to provide a braking force to the cable, when a rate at which the corresponding deployable structure exceeds a first predetermined deployed rate.

7. The system according to claim 5 wherein the deployment rate limiter is further configured to reduce a rate of deployment of the deployable structure as a deployment of the corresponding deployable structure approaches a substantially completed condition.

8. The system according to claim 5, wherein the deployment rate limiter is further configured to substantially prevent or reduce damage to the deployable structure.

9. The system according to claim 1, wherein the parachute deployment system comprises:
a plurality of tubes; and
at least one cable connected to the deployable structure, interfaced with each of the plurality of tubes, and mechanically coupled to the drogue parachute, wherein
each of the plurality of tubes is configured to redirect the applied tension to one or more components of the at least one deployable structure.

10. The system according to claim 9, further comprising:
a cable cutter configured to sever the cable following extension of the at least one deployable structure.

11. The system according to claim 9, further comprising:
one or more jam cleats, wherein
each of the one or more jam cleats is configured to allow substantially one-way travel of the at least one cable in the direction of the applied tension following deployment of the drogue parachute.

12. The system according to claim 9, further comprising:
one or more deployment rate limiters, wherein
the at least one cable interfaces with at least one of the one or more deployment rate limiters, and wherein
each of the one or more deployment rate limiters is configured to limit a deployment rate of a corresponding one of the at least one deployable structures.

13. The system according to claim 12, wherein each deployment rate limiter is configured to provide a braking force to the cable, when a rate at which the corresponding deployable structure exceeds a first predetermined deployed rate.

14. The system according to claim 13, wherein the deployment rate limiter is further configured to reduce a rate of deployment of the deployable structure as a deployment of the corresponding deployable structure approaches a substantially completed condition.

15. The system according to claim 13, wherein the deployment rate limiter is further configured to substantially prevent or reduce damage to the deployable structure.

16. The system according to claim 1, wherein the at least one the deployable structure comprises a telescoping wing structure.

17. The system according to claim 1, wherein the at least one deployable structure comprises a foldable wing structure.

18. The system according to claim 1, wherein the at least one deployable structure comprises a landing gear structure.

19. A system for deploying a structure in an aircraft, comprising:
a drogue parachute;
at least one deployed structure;
a riser line attached to the drogue parachute and the at least one deployable structure, wherein when the drogue parachute is deployed, a tension is applied to the riser line; and
a pulley system, wherein the pulley system is configured to utilize the applied tension to deploy the at least one deployable structure.

20. The system according to claim 19, wherein the at least one deployable structure comprises a telescoping structure.

21. The system according to claim 19, wherein the at least one deployable structure comprises a foldable structure.

22. An aircraft, comprising:
a fuselage;
a deployable wing structure appended to the fuselage;
a plurality of deployable vertical and horizontal stabilizer structures appended to the fuselage; and
a system for deploying a deployable structure in the aircraft, the system including
a drogue parachute;
a riser line attached to the drogue parachute and each of the deployable wing structure and plurality of deployable vertical and horizontal stabilizer structures, wherein when the drogue parachute is deployed, a tension is applied to the riser line; and
a parachute deployment system, wherein the parachute deployment system is configured to utilize the parachute riser line tension to deploy each of the deployable wing structure and plurality of deployable vertical and horizontal stabilizer structures.

23. The aircraft according to claim 22, wherein the parachute deployment system comprises:
at least one pulley wheel; and
at least one cable connected to the deployable structure, interfaced with the at least one more pulley wheel, and mechanically coupled to the drogue parachute.

24. The aircraft according to claim 23, further comprising:
a cable cutter configured to sever the cable following extension of each of the deployable wing structure and plurality of deployable vertical and horizontal stabilizer structures.

25. The aircraft according to claim 23, further comprising:
one or more jam cleats, wherein
each of the one or more jam cleats is configured to allow substantially one-way travel of the at least one cable in the direction of the applied tension following deployment of the drogue parachute.

26. The aircraft according to claim 23, further comprising:
one or more deployment rate limiters, wherein
the at least one cable interfaces with at least one of the one or more deployment rate limiters, and wherein
each of the one or more deployment rate limiters is configured to limit a deployment rate of a corresponding one of each of the deployable wing structure and plurality of deployable vertical and horizontal stabilizer structures.

27. The aircraft according to claim 26, wherein each deployment rate limiter is configured to provide a braking force to the cable, when a rate at which each of the deployable wing structure and plurality of deployable vertical and horizontal stabilizer structures exceeds a first predetermined deployed rate.

28. The system according to claim 26 wherein, the deployment rate limiter is further configured to reduce a rate of deployment of each of the deployable wing structure and plurality of deployable vertical and horizontal stabilizer structures as deployment of the corresponding deployable wing structure and plurality of deployable vertical and horizontal stabilizer structures approaches a substantially completed condition.

29. The system according to claim 26, wherein the deployment rate limiter is further configured to prevent or reduce damage to each of the deployable wing structure and plurality of deployable vertical and horizontal stabilizer structures.

30. The aircraft according to claim 22, wherein the parachute deployment system comprises:
a plurality of tubes; and
at least one cable connected to each of the deployable wing structure and plurality of deployable vertical and horizontal stabilizer structures, interfaced with each of the plurality of tubes, and mechanically coupled to the drogue parachute, wherein
each of the plurality of tubes is configured to redirect the applied tension to each of the deployable wing structure and plurality of deployable vertical and horizontal stabilizer structures.

31. The aircraft according to claim 30, further comprising:
a cable cutter configured to sever the cable following extension of each of the deployable wing structure and plurality of deployable vertical and horizontal stabilizer structures.

32. The aircraft according to claim 30, further comprising:
one or more jam cleats, wherein
each of the one or more jam cleats is configured to allow substantially one-way travel of the at least one cable in the direction of the applied tension following deployment of the drogue parachute.

33. The aircraft according to claim 30, further comprising:
one or more deployment rate limiters, wherein
the at least one cable interfaces with at least one of the one or more deployment rate limiters, and wherein
each of the one or more deployment rate limiters is configured to limit a deployment rate of a corresponding one of each of the deployable wing structure and plurality of deployable vertical and horizontal stabilizer structures.

34. The aircraft according to claim 33, wherein each deployment rate limiter is configured to provide a braking force when a rate at which the corresponding deployable wing structure and plurality of deployable vertical and horizontal stabilizer structures exceeds a first predetermined deployment rate.

35. The system according to claim 33, wherein the deployment rate limiter is further configured to reduce a rate of deployment of each of the deployable wing structure and plurality of deployable vertical and horizontal stabilizer structures.

36. The system according to claim 30, wherein the deployment rate limiter is further configured to prevent or reduce damage to the deployable structure.

37. The aircraft according to claim 22, wherein the aircraft comprises a lightweight aircraft.

38. The aircraft according to claim 22, wherein the aircraft comprises a solar powered aircraft.

39. The aircraft according to claim 22, wherein the aircraft comprises a sail plane.

40. A method for deploying a deployable structure on an airborne aircraft, comprising the steps of:
deploying a drogue parachute from the airborne aircraft,
wherein the drogue parachute is mechanically coupled to the deployable structure; and
using a tension force being applied as a result of the deployed drogue parachute to enable deployment of the deployable structure.

41. The method for according to claim 40, wherein the step of using the tension force comprises:
redirecting the applied tension force through at least one pulley wheel and at least one cable connected to the deployable structure, the at least one cable being interfaced with the at least one pulley wheel, and mechanically coupled to the drogue parachute.

42. The method according to claim 40, wherein the step using the tension force comprises:
redirecting the applied tension force through at least one tube and at least one cable connected to the deployable structure, the at least one cable being interfaced with the at least one pulley wheel, and mechanically coupled to the drogue parachute.

43. The method according to claim 40, wherein the method further comprises:
using at least one deployment rate limiter to limit a rate of deployment of the deployable structure.

44. The method according to claim 43, wherein the step of using at least one deployment rate limiter comprises:
providing a braking force should deployment of the deployable structure exceed a first predetermined deployment rate.

45. The method according to claim 44, wherein the step of providing a braking force comprises:
reducing the rate of deployment of the deployable structure as the corresponding deployable structure approaches a substantially completed condition.

46. The method according to claim 44, further comprising:
reducing the rate of deployment of the deployable structure to substantially prevent or reduce damage to the deployable structure.

47. The method according to claim 40, wherein the deployable structure comprises a telescoping wing structure.

48. The method according to claim 40, wherein the deployable structure comprises a foldable wing structure.

49. The method according to claim 40, wherein the deployable structure comprises a landing gear structure.
